(19) United States
(12) Patent Application Publication
(10) Pub. No.: US 2012/0021154 A1
(43) Pub. Date: Jan. 26, 2012

(54) Biodegradable Tableware and Cosmetic Case

(76) Inventors: Chien-Ming Huang, Taichung City (TW); Yu-Kai Huang, Taichung County (TW)

(21) Appl. No.: 12/840,753

(22) Filed: Jul. 21, 2010

(51) Int. Cl. B32B 1/02; B32B 27/18; C08K 3/34; C08L 33/02; C08K 3/26; B32B 15/08; C08F 118/14

(52) U.S. Cl. 428/35.8; 428/36.92; 428/36.4; 526/319; 525/190; 524/425; 524/449; 524/445; 524/451

(57) ABSTRACT

A biodegradable tableware includes a molded structure made from a biodegradable plastic composition including polybutylene-1,4-succinate. A biodegradable cosmetic case is also provided.

### BACKGROUND OF THE INVENTION

1. Field of the Invention

This invention relates to a formed article made of a polymer material, particularly to a biodegradable tableware and a biodegradable cosmetic case, both of which have required physical properties and are degradable in natural environment.

2. Description of the Related Art

A conventional fresh keeper, such as a food storage box, is one kind of widely used tableware and is made of polymer materials capable of being easily processed.

The conventional fresh keeper is mainly used for preserving foods by retarding water evaporation from the foods and separating different kinds of foods from each other so as to prevent the foods from being contaminated with each other and so as to prolong the storage life of the foods. However, the conventional fresh keeper still has the following drawbacks.

The conventional fresh keeper is usually made of a polymer material having good processability, heat-resistance and mechanical strength, such as polystyrene (PS) or polypropylene (PP). However, PS and PP are stable in natural environment and tend to result in environmental problems. Besides, the fresh keeper made of PS is likely to release toxic substances when holding a relatively hot food, with the result that the food contained in the box may become contaminated.

### SUMMARY OF THE INVENTION

Therefore, an object of the present invention is to provide a biodegradable tableware and a biodegradable cosmetic case that are environment-friendly, and that can provide desired physical properties.

According to one aspect of the present invention, there is provided a biodegradable tableware comprising: a molded structure made from a biodegradable plastic composition including polybutylene-1,4-succinate.

According to another aspect of the present invention, there is provided a biodegradable cosmetic case comprising: a molded structure made from a biodegradable plastic composition including polybutylene-1,4-succinate.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic view of the preferred embodiment of a biodegradable tableware according to the present invention, which is in a form of a fresh keeper;

FIG. 2 is a cross-sectional view of FIG. 1;

FIG. 3 is a schematic view of another preferred embodiment of a biodegradable tableware according to the present invention, which is in a form of a fork;

FIG. 4 is a schematic view of the preferred embodiment of a biodegradable cosmetic case according to the present invention, which is in a form of a cosmetic case; and

FIG. 5 is a cross-sectional view of another preferred embodiment of a biodegradable cosmetic case, which is coated with a metal layer.

### DETAILED DESCRIPTION OF THE PREFERRED EMBODIMENTS

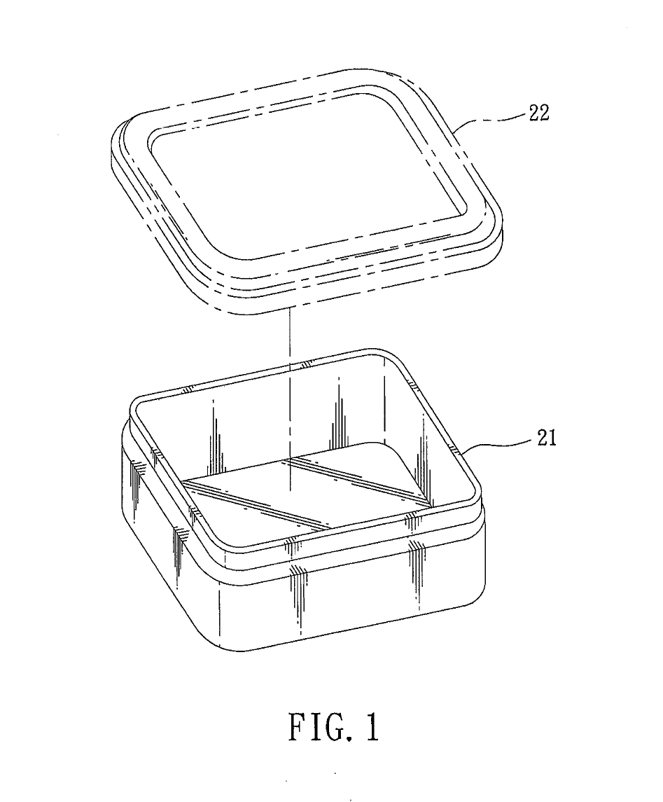

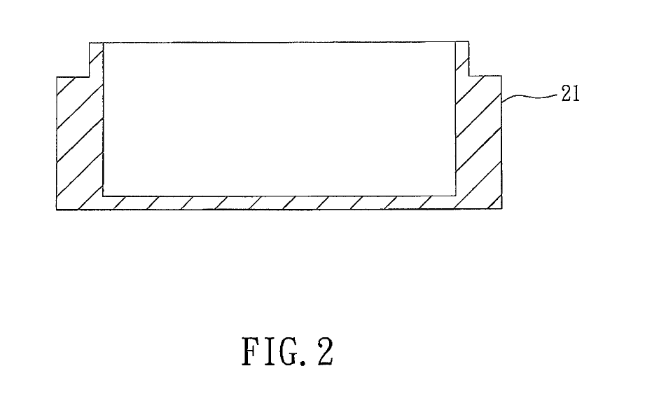

Referring to FIGS. 1 and 2, a biodegradable tableware in a form of a fresh keeper according to the first preferred embodiment of the present invention includes a molded structure 21.

The molded structure 21 is made from a biodegradable plastic composition and is molded into a predetermined shape by a predetermined method. The major component of the biodegradable plastic composition is polybutylene-1,4-succinate (PBS). In this invention, since the method for making the molded structure 21 may be the same as the method for fabricating the conventional fresh keeper made of PS or PP and is known in the relevant art, the detailed description thereof will be omitted herein.

Preferably, the biodegradable plastic composition further includes polylactic acid (PLA) in an amount of 0-30% by weight based on a total weight of the biodegradable plastic composition. Since a product made of PLA has a relatively large rigidity in room temperature, the rigidity and the dimensional stability of the molded structure 21 in room temperature can be greatly improved by adding PLA to the biodegradable plastic composition.

Besides, the biodegradable plastic composition may further include a filler. Preferably, the filler is in an amount of 15-35 parts by weight based on 100 parts by weight of the biodegradable plastic composition. By way of illustration, the filler is selected from the group consisting of calcium carbonate, mica, clay, a silicate, talc, and combinations thereof.

PBS has mechanical properties like those of PP and linear low-density polyethylene (LLDPE) and better than those of other biodegradable plastic materials. Furthermore, PBS has a heat deflection temperature (HDT) of up to about 90° C. Hence, PBS can be easily processed into the molded structure 21 with the predetermined shape, and the mechanical strength and the tensile strength of the molded structure 21 can be adjusted by controlling the amounts of PLA and the filler added to PBS so as to conform to the requirements for actual applications. Besides, since the molded structure 21 has the major component of PBS, it has an improved durability due to a relatively good heat-resistance and resistance to deformation or breaking at a relatively high temperature in addition to the environment-friendly biodegradation property.

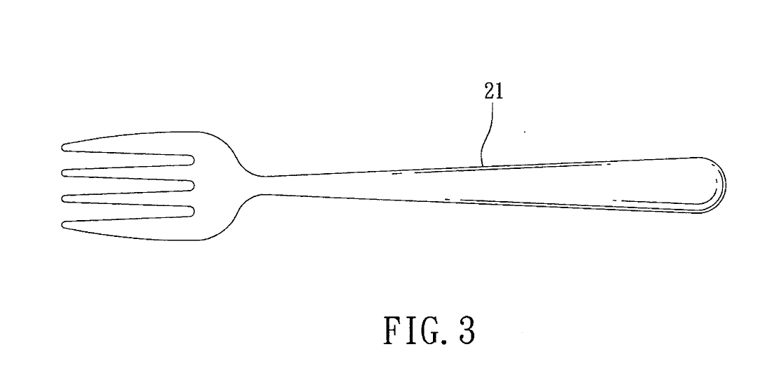

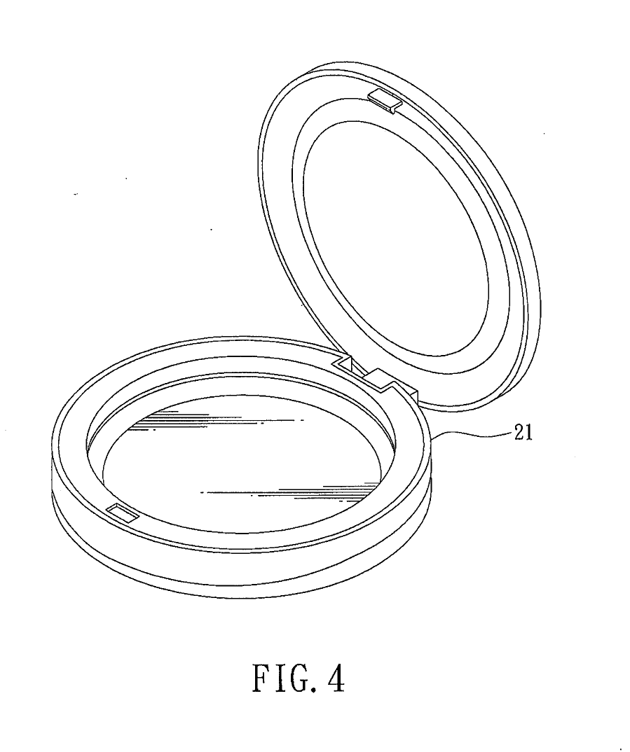

Of course, the application of the molded structure 21 is not limited, and the molded structure 21 can be formed or molded into any shape according to the intended use. As shown in FIG. 1, when the molded structure 21 is formed as the fresh keeper, it can further include a cover 22 and can be used for preserving foods, such as meat, fish, fruits, dried fruits, nuts, tea leaf, beans, etc. Referring to FIG. 3, although the molded structure 21 is shown to be formed into a fork, it can also be formed into other types of cutlery, such as knives, spoons, chopsticks and so on. When the molded structure 21 of the fork shown in FIG. 3 is brought into contact with a hot food, it is unlikely to deform or produce toxic substances since it is made of PBS having a relatively high heat deflection temperature. On the other hand, since the tableware of the present invention is safe and biodegradable, it is also suitable for use as a disposable tableware. Referring to FIG. 4, the molded structure 21 is formed in a form of a cosmetic case and includes a case body and a cover body, and the case body can be used for receiving cosmetics. When the cosmetic case is emptied and is subsequently discarded, the cosmetic case is degradable in natural environment or can be recycled.

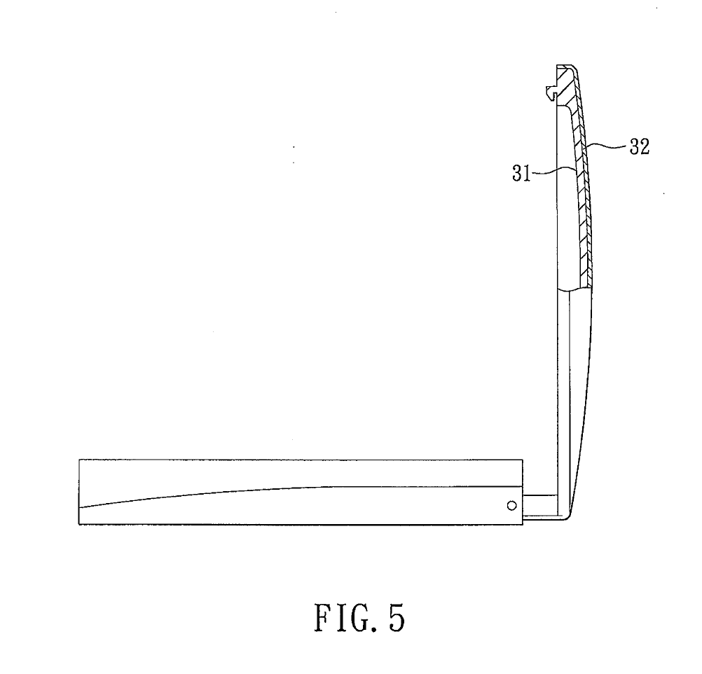

Referring to FIG. 5, a cosmetic case of another preferred embodiment according to the present invention includes a molded structure 31 and a metal layer 32.

The molded structure 31 of the cosmetic case shown in FIG. 5 has the same structure and property as that of the cosmetic case of FIG. 4, and the detailed description thereof is omitted. The metal layer 32 is formed on and bonded to the molded structure 31 using a chemical vapor deposition method, and is made of a metal element, for example, gold, silver, copper, zinc, etc. By forming the metal layer 32 on the molded structure 31, the cosmetic case can provide better durability and serviceability. Thus, the cosmetic case shown in FIG. 5 is suitable for storing cosmetics having a relatively long shelf life. Besides, the metal layer 32 can impart the cosmetic case with a mirror effect and a glossy appearance, and can be formed to cover all surfaces of the molded structure 31 or partially formed on visible surfaces when the cosmetic case is closed.

### EXAMPLES

Specimens of examples 1 to 7 for assessment of the properties of the molded structure are made from the formulations of the biodegradable plastic composition shown in Table 1. PBS is a commercial product available from Mitsubishi Chemical Industries, Ltd. under a trade name of GS pla AZ91.

TABLE 1

| | Biodegradable plastic | | |
|---|---|---|---|
| | composition of Specimens | | |
| | PBS | PLA | Filler |
| | (parts by | (parts by | (parts by |
| Ex. | weight) | weight) | weight) |
| 1 | 100 | 0 | 0 |
| 2 | 100 | 0 | 15 |
| 3 | 100 | 0 | 25 |
| 4 | 100 | 0 | 30 |
| 5 | 87 | 13 | 30 |
| 6 | 87 | 13 | 35 |
| 7 | 70 | 30 | 30 |

The test results of the properties for each of the specimens are shown in Table 2.

TABLE 2

| Test Item | Example | | | | | | |
|---|---|---|---|---|---|---|---|
| (Test method) | 1 | 2 | 3 | 4 | 5 | 6 | 7 |
| Melting | 110 | 110 | 110 | 110 | 145 | 145 | 145 |
| Temperature | | | | | | | |
| Density (g/cm³) | 1.26 | 1.33 | 1.36 | 1.36 | 1.44 | 1.5 | 1.38 |
| (ASTM D792) | | | | | | | |
| Tensile | 428.3 | 337.3 | 330.0 | 313.0 | 350.0 | 232.0 | 300.3 |
| Strength | | | | | | | |
| (Kgf/cm²) | | | | | | | |
| (ASTM D638) | | | | | | | |
| Elongation | 220 | 20.0 | 15.0 | 19.0 | 7.4 | 5.7 | 11.2 |
| Ratio (%) | | | | | | | |
| (ASTM D638) | | | | | | | |
| Yield Strength | 356.9 | 344.5 | 347.0 | 363.0 | 361.0 | 334.0 | 396.5 |
| (Kgf/cm2) | | | | | | | |
| (ASTM D638) | | | | | | | |
| Impact Strength | — | 76.6 | 72.5 | 56.5 | 48.7 | 38.5 | 40.2 |
| (J/m) | | | | | | | |
| (ASTM D256) | | | | | | | |
| HDT (° C.) | 91.0 | 86.3 | 88.8 | 90.6 | 86.0 | 89.4 | 73.6 |
| (under load of 66 | | | | | | | |
| psi) | | | | | | | |
| (ASTM D648) | | | | | | | |
| Melt Flow Rate | 4.5 | 11.01 | 10.47 | 10.59 | 14.24 | 18.92 | 8.51 |
| (190° C., 2.16 kg) | | | | | | | |
| (g/10 min) | | | | | | | |
| (ASTM D1238) | | | | | | | |
| Hardness | 73 | 78 | 83 | 85 | 88 | 93 | 89 |
| (Shore D) | | | | | | | |
| (ASTM D785) | | | | | | | |
| Color | white | white | white | white | white | white | white |
| Mold Shrinkage | — | 0.947 | 0.024 | 1.000 | 0.780 | 0.850 | 0.246 |
| Ratio (%) | | | | | | | |

As shown in Table 2, the properties of the specimens vary with adjustment in the formulations of the biodegradable plastic composition.

(1) When the filler is added (see Examples 1 and 2), the melt flow rate will be increased. It is noted that the filler will improve the processability of the biodegradable plastic composition.

(2) When the amount of the filler is increased (see Examples 2 to 4), the HTD and the yield strength of the specimens will also increase. It is noted that the amount of the filler can be increased if a good processability of the biodegradable plastic composition and a good HTD of the molded structure are both desired. Besides, although the increase of the amount of the filler can improve the processability and the yield strength, the specimens are likely to break due to an external force when the amount of the filler is too high. Therefore, the tensile strength will decrease with the increase of the amount of the filler.

(3) When the biodegradable plastic composition further includes PLA (see Examples 4 and 5), the tensile strength of the specimens will increase but the elongation ratio will decrease. Accordingly, the addition of PLA can improve the rigidity and the dimensional stability of the molded structure. However, compared to the specimen of Example 7, when PLA increases to 30 wt % based on the total amount of PBS and PLA, the elongation ratio of the specimens increases, but the tensile strength thereof decreases. Therefore, if the molded structure is required to have a relatively good rigidity, the amount of PLA should be controlled.

(4) When the amount of the filler increases from 30 weight parts to 35 weight parts based on 100 parts of the total weight of PBS and PLA (see Examples 5 and 6), the tensile strength will greatly decrease. It is noted that although the increase of filler amount can improve the processability and the yield strength (see Examples 2 to 4), the specimens are likely to break due to the external force. Therefore, the amount of the filler should not be higher than 35 weight parts based on 100 parts of the total weight of PBS and PLA.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A biodegradable tableware comprising:
a molded structure made from a biodegradable plastic composition including polybutylene-1,4-succinate.

2. The biodegradable tableware of claim 1, wherein said biodegradable plastic composition further includes polylactic acid in an amount of 0-30% by weight based on a total weight of the biodegradable plastic composition.

3. The biodegradable tableware of claim 2, wherein said biodegradable plastic composition further includes a filler in an amount of 15-35 parts by weight based on 100 parts by weight of the biodegradable plastic composition, the filler being selected from the group consisting of calcium carbonate, mica, clay, a silicate, talc, and combinations thereof.

4. A biodegradable cosmetic case comprising:
a molded structure made from a biodegradable plastic composition including polybutylene-1,4-succinate.

5. The biodegradable cosmetic case of claim 4, wherein said biodegradable plastic composition further includes polylactic acid in an amount of 0-30% by weight based on a total weight of the biodegradable plastic composition.

6. The biodegradable cosmetic case of claim 5, wherein said biodegradable plastic composition further includes a filler in an amount of 15-35 parts by weight based on 100 parts by weight of the biodegradable plastic composition, the filler being selected from the group consisting of calcium carbonate, mica, clay, a silicate, talc, and combinations thereof.

7. The biodegradable cosmetic case of claim 4, further comprising a metal layer formed on said molded structure.
